(19) United States
(12) Patent Application Publication
(10) Pub. No.: US 2026/0065038 A1
(43) Pub. Date: Mar. 5, 2026

(54) METHOD AND ELECTRONIC DEVICE FOR GENERATING LANGUAGE MODEL

(71) Applicant: Sionic AI Inc., Seoul (KR)

(72) Inventors: Jeonghwan Park, Seoul (KR); Woomyoung Park, Seoul (KR); Sukhyun Ko, Seoul (KR)

(21) Appl. No.: 19/088,124

(22) Filed: Mar. 24, 2025

(30) Foreign Application Priority Data
Sep. 4, 2024 (KR) 10-2024-

(51) Int. Cl. G06N 3/048

(52) U.S. Cl. CPC G06N 3/048

(57) ABSTRACT

The present disclosure relates to a method for generating a language model performed by at least one processor, the method including obtaining a base model pre-trained with a large-scale corpus, a functional model with a specified function added to the base model, and a target model additionally trained on the base model with learning data of a specified domain, calculating a first difference value between a first parameter of the functional model and a second parameter of the base model corresponding to the first parameter, calculating a change ratio of a third parameter of the target model corresponding to the second parameter with respect to the second parameter, and generating a new model from the target model based on the first difference value and the change ratio.

### CROSS-REFERENCE TO RELATED APPLICATION

This application claims priority under 35 U.S.C. § 119 to Korean Patent Application No. 10-2024-0120089, filed in the Korean Intellectual Property Office on Sep. 4, 2024, the entire contents of which are hereby incorporated by reference.

### BACKGROUND

### Field

The present disclosure relates to a method for generating a language model and an electronic device.

### Discussion of the Background

In the field of natural language processing technology, technologies are currently in development for optimizing the performance of a model according to the user demands by adding desired functions through supervised fine-tuning (SIFT) or reinforcement learning from human feedback (RALF), etc. using a large language model (LLM) as a base model. For example, when the LLM is trained in a specific language, a problem may arise in which a specific language appears in the field that requires the generation of another language, so that additional training may be performed in the language to be used. As another example, when the LLM is trained with general knowledge, the LLM may lack specialized knowledge in a specific field or may not have the ability to meet the data and requirements of a specific company, so that the LLM may be tuned to suit the specialized knowledge in the field or the needs of the company.

In general, when additional tuning is performed for a specific purpose by using the LLM, a base model is used. However, when additional fine-tuning or continuous learning is performed on a model to which a specified function is added to the base model through set or RLHF, etc., it may be difficult to obtain a model with the desired performance. For example, a catastrophic forgetting phenomenon may occur, which loses the existing capability during the additional tuning process. In addition, when the base model is additionally learned with learning data of a specified domain, a huge amount of learning data and learning resources may be required when SFT or RLHF, etc. is performed to grant a specific capability again. Accordingly, a need has arisen for the development of technologies that generate a new model without a learning process by using a functional model with a specified function added to a base model and a target model additionally trained on the base model with learning data from a specified domain.

### SUMMARY

A present disclosure is aimed to provide a method for generating a language model and an electronic device for solving the above-described problems.

The present disclosure is implemented in various forms including a method, a device (system) and/or a non-transitory computer-readable recording medium that stores computer-readable commands.

According to the present disclosure, there is provided a method for generating a language model performed by at least one processor, the method including obtaining a base model pre-trained with a large-scale corpus, a functional model with a specified function added to the base model, and a target model additionally trained on the base model with learning data of a specified domain, calculating a first difference value between a first parameter of the functional model and a second parameter of the base model corresponding to the first parameter, calculating a change ratio of a third parameter of the target model corresponding to the second parameter with respect to the second parameter, and generating a new model from the target model based on the first difference value and the change ratio.

The calculating of the change ratio may include calculating a second difference value between the third parameter and the second parameter, and obtaining the change ratio by inputting the second difference value to an activation function.

The activation function may include at least one of a sigmoid function or a ReLU (Rectified Linear Unit) function.

The method may further include obtaining an absolute value of the second difference value and normalizing the absolute value before inputting the second difference value to the activation function.

The generating of the new model may include, generating the new model based on a value obtained by multiplying the change ratio subtracted from 1 by the first difference value and adding a result of the multiplication to the third parameter.

The first difference value and the change ratio may be calculated for each corresponding layer of the base model, the functional model, and the target model.

The specified function may include at least one of a response generation function for commands, a chat function, a retrieval-augmented generation function, a context expansion function, or a coding function.

The specified domain may include at least one of a language domain from at least one other country, an expert knowledge domain, or a corporate domain.

According to the present disclosure, there is provided a non-transitory computer-readable recording medium storing computer-readable commands, based on the commands being executed by at least one processor, wherein the at least one processor is configured to, obtain a base model pre-trained with a large-scale corpus, a functional model with a specified function added to the base model, and a target model additionally trained on the base model with learning data of a specified domain, calculate a first difference value between a first parameter of the functional model and a second parameter of the base model corresponding to the first parameter, calculate a change ratio of a third parameter of the target model corresponding to the second parameter with respect to the second parameter, and generate a new model from the target model based on the first difference value and the change ratio.

According to the present disclosure, there is provided an electronic device including a memory, and at least one processor connected to the memory and configured to execute computer-readable commands stored in the memory, wherein the at least one processor is configured to obtain a base model pre-trained with a large-scale corpus, a functional model with a specified function added to the base mode, and a target model additionally trained on the base model with learning data of a specified domain, calculate a first difference value between a first parameter of the functional model and a second parameter of the base model corresponding to the first parameter, calculate a change ratio of a third parameter of the target model corresponding to the second parameter with respect to the second parameter, and generate a new model from the target model based on the first difference value and the change ratio.

The at least one processor may be configured to calculate a second difference value between the third parameter and the second parameter, and obtain the change ratio by inputting the second difference value to an activation function.

The at least one processor may be configured to obtain an absolute value of the second difference value and normalize the absolute value before inputting the second difference value into the activation function.

The at least one processor may be configured to generate the new model based on a value obtained by multiplying the change ratio subtracted from 1 by the first difference value and adding a result of the multiplication to the third parameter.

According to one or more aspects of the present disclosure, generation of a language model may be supported more conveniently and efficiently by generating a new model without a learning process by using a functional model with a specific function added to a base model, and a target model additionally trained on the base model with learning data from a specified domain.

According to one or more aspects of the present disclosure, generation of a language model with the capability of the function model added to the target model may be supported without a learning process by generating a new model based on a difference value of respective parameters corresponding to the base model and the functional model and a change ratio of respective parameters corresponding to the base model and the target model.

The effect of the present disclosure is not limited to the effect described above, and other effects not mentioned will be clearly understood by a person having ordinary skill in the art (referred to as “those skilled in the art”) to which the present disclosure pertains from the description of the claims.

### BRIEF DESCRIPTION OF DRA WINGS

Embodiment(s) of the present disclosure will be described in detail with reference to the attached drawings. Like reference numerals in the drawings denote like elements, but the present disclosure is not limited thereto.

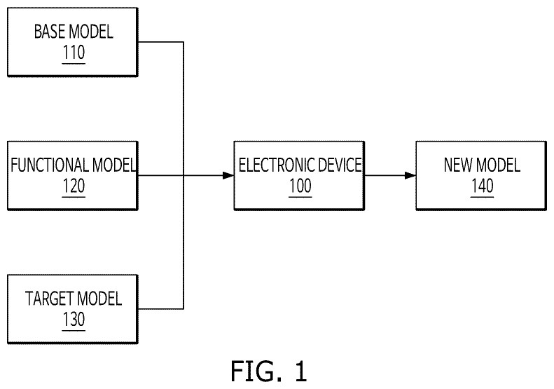

FIG. 1 is an exemplary view illustrating an electronic device for generating a language model;

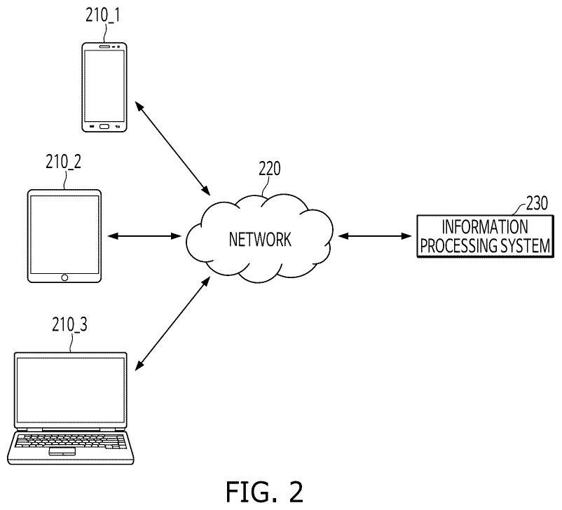

FIG. 2 is an outline view illustrating a configuration where an information processing system is connected to a plurality of user terminals for communication with reference to data processing;

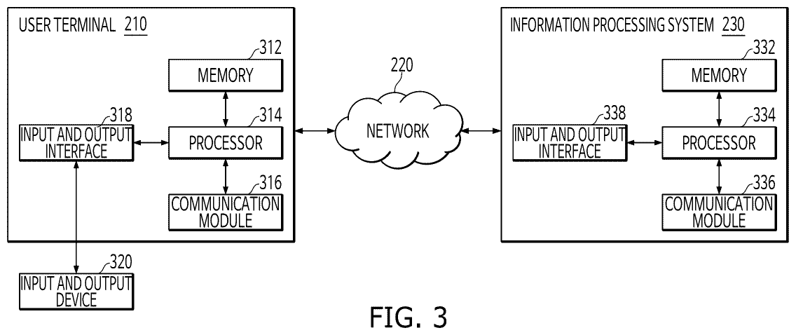

FIG. 3 is a block view illustrating internal configurations of a user terminal and an information processing system;

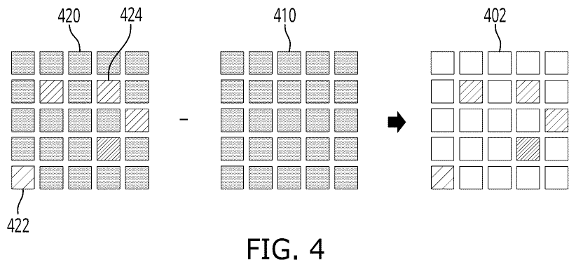

FIG. 4 is a view illustrated to explain a method for calculating a different value of respective parameters corresponding to a base model and a functional model;

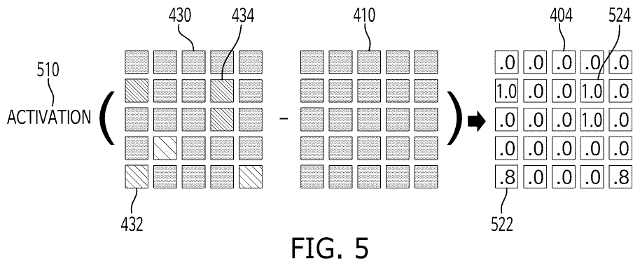

FIG. 5 is a view illustrated to explain a method for calculating a change ratio of respective parameters corresponding to a base model and a target model;

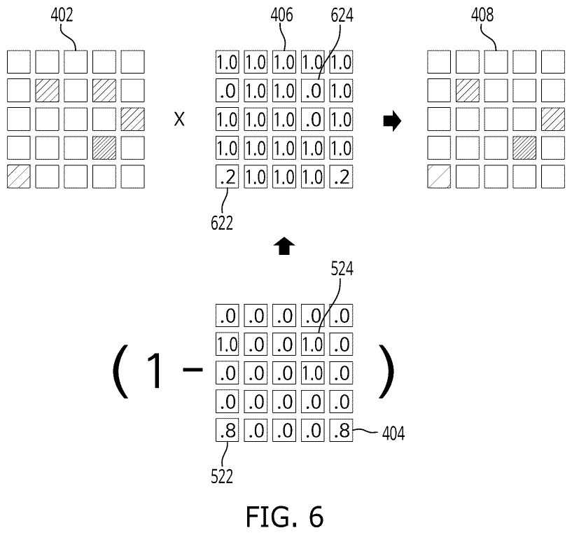

FIG. 6 is a view illustrated to explain a method for applying a calculated conversion ratio to a calculated difference value;

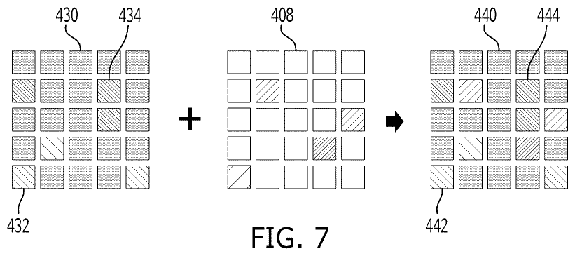

FIG. 7 is a view illustrated to explain a method for generating a new model by using a value obtained by applying a calculated conversion ratio to a calculated difference value;

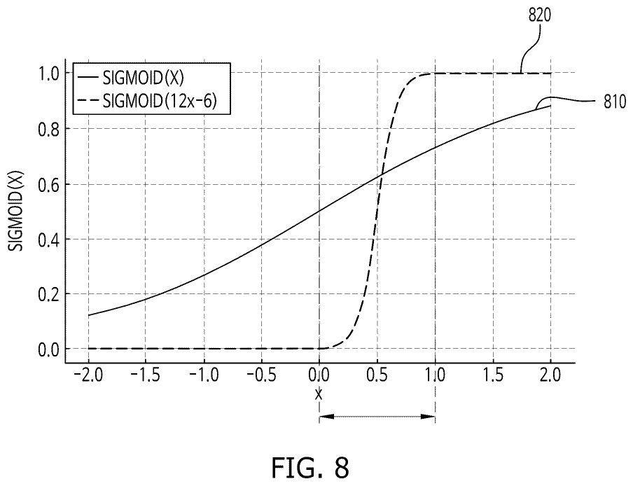

FIG. 8 is a view illustrated to explain an activation function used for calculating a change ratio;

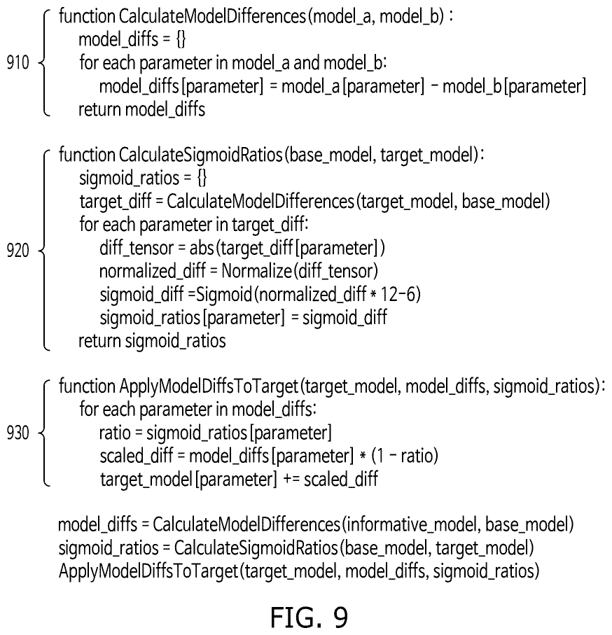

FIG. 9 is a view illustrating a pseudo code used for generating a language model; and

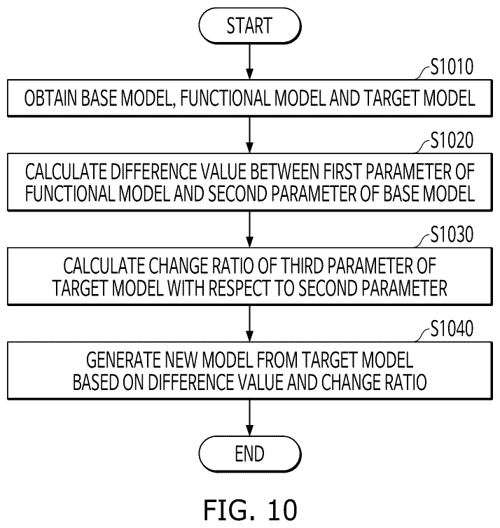

FIG. 10 is a view illustrated to explain a method for generating a language model.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Accordingly, the terms used in this disclosure should be defined based on the meaning of the term and the overall content of the present disclosure, rather than simply the name of the term.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

A “module” or “unit” may be implemented as a processor and a memory, or may be implemented as a circuit (circuitry). Terms such as circuit and circuitry may refer to circuits in hardware, but may also refer to circuits in software. The “processor” should be interpreted broadly to encompass a general-purpose processor, a central processing unit (CPU), a microprocessor, a digital signal processor (DSP), a neural processing unit (NPU), a controller, a microcontroller, a state machine, etc. Under some circumstances, the “processor” may refer to an application-specific integrated circuit (ASIC), a programmable logic device (PLD), a field-programmable gate array (FPGA), etc. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. The memory is said to be in electronic communication with a processor if the processor can read information from and/or write information to the memory. The memory integrated with the processor is in electronic communication with the processor.

In addition, terms such as first, second, A, B, (a), (b), etc. used in the following examples are only used to distinguish certain components from other components, and the nature, sequence, order, etc. of the components are not limited by the terms.

In addition, in the following examples, if a certain component is stated as being “connected,” “combined” or “coupled” to another component, it is to be understood that there may be yet another intervening component “connected,” “combined” or “coupled” between the two components, although the two components may also be directly connected or coupled to each other.

In addition, as used in the following examples, “comprise” and/or “comprising” does not foreclose the presence or addition of one or more other elements, steps, operations, and/or devices in addition to the recited elements, steps, operations, or devices.

Hereinafter, various examples of the present disclosure will be described in detail with reference to the accompanying drawings.

FIG. 1 is an exemplary view illustrating an electronic device 100 for generating a language model according to embodiments of the present disclosure. Referring to FIG. 1, an electronic device 100 may generate a new model 140 by using a base model 110, a functional model 120, and a target model 130. For example, the electronic device 100 may generate a new model 140 without learning by using the functional model 120 with a specified function added to the base model 110, and the target model 130 additionally trained on the base model 110 with learning data of a specified domain. The electronic device 100 may generate the new model 140 based on a difference value of respective parameters corresponding to the base model 110 and the functional model 120 and a change ratio of respective parameters corresponding to the base model 110 and the target model 130.

The base model 110 may be a basic model that is not specialized for a specific task, and may be pre-trained using a large general dataset and then fine-tuned for a specific task or domain. For example, the base model 110 may represent a language model that is pre-trained using a large-scale corpus.

The functional model 120 may be a model with a specified function added to the base model 110, and may retain a specified function by performing additional learning and alignment learning based on the base model 110. According to embodiments, the specified function may include at least one of a response generation function for commands (e.g., an instruction following function), a chat function, a retrieval augmentation generation function (e.g., a retrieval augmented generation (RAG) function), a context expansion function, or a coding function. Methods for generating the functional model 120 by adding a specified function to the base model 110 may include SFT, RLHF, etc. The SFT may be a method of fine-tuning the base model 110 for a specific task, for example, through supervised learning, and a dataset with labels for given tasks may be used. The RLHF may be a method of improving the output of a model through human feedback, for example, the RLHF may collect feedback, which is evaluation data, for the output generated by the model tuned through the SFT, learn a reward model by using the collected feedback, and optimize the policy of the model through the reward model. During the process, reinforcement learning may be used to allow the model to generate outputs for high rewards.

The target model 130 may represent a model that performs additional learning on the base model 110 with learning data of a specified domain. The domain may represent language, term knowledge, etc. related to a specific theme or field and define a theme area to which a language model is trained and applied. For example, the language model specified in a specific domain may have the capability of understanding and appropriately processing languages, grammar, styles, contexts, etc. mostly used in the domain. According to embodiments, the specified domain may include at least one of a language domain from at least one other country, an expert knowledge domain or a corporate domain.

The electronic device 100 for generating the language model may include a memory and at least one processor. However, the configuration of the electronic device 100 is not limited thereto. According to various embodiments, the electronic device 100 may further include at least one additional component than the above-described components. For example, the electronic device 100 may further include a communication circuit (or a communication module) for communication with an external electronic device.

The processor may be connected to a memory and configured to execute at least one computer-readable program included in the memory. For example, the processor may control at least one other component (e.g., hardware or software components) of the electronic device 100 connected to the processor by executing software (or programs), and perform various data processing or calculations. According to embodiments, at least a part of data processing or calculation, the processor may load commands or data received from other components (e.g., a communication circuit) to a non-volatile memory, process the commands or data stored in the non-volatile memory, and store result data in the non-volatile memory.

The memory may store various data used by at least one component (e.g., a processor) of the electronic device 100. The data may include, for example, software (or programs) and input data or output data for the related commands. The memory may include a volatile memory or a non-volatile memory.

At least one program executed by the processor may include commands related to the generation of the language model. Although the processor is described as performing functions, but it is merely for convenience of explanation, but the function performed by the processor may be understood as the execution of the commands included in at least one program stored in the memory.

The processor may obtain the base model 110 that is pre-trained using a large-scale corpus, the functional model 120 with a specified function added to the base model 110, and the target model 130 additionally trained on the base model 110 with learning data of a specified domain.

The processor may calculate a difference value between respective parameters corresponding to the base model 110 and the functional model 120. For example, the processor may calculate a difference value (referred to a first difference value) between the parameter (referred to as a first parameter) of the functional model 120 and the parameter (referred to as a second parameter) of the base model 110 corresponding to the first parameter.

The processor may calculate a change ratio of respective parameters corresponding to the base model 110 and the target model 130. For example, the processor may calculate a change ratio of the parameter (referred to as a third parameter) of the target model 130 corresponding to the second parameter with respect to the second parameter of the base model 110. According to embodiments, the processor may calculate a difference value (referred to as a second difference value) between the third parameter of the target model 130 and the second parameter of the base model 110 and input the second difference value to an activation function to obtain a change ratio. The activation function may include at least one of a sigmoid function or a ReLU (Rectified Linear Unit) function. According to embodiments, the processor may obtain the absolute value of the second difference value and then normalize the absolute value before inputting the second difference value to the activation function. For example, the processor may adjust the input value of the activation function to be a real value greater than or equal to 0 (zero) and smaller than or equal to 1 (one).

The processor, based on the first difference value and the first difference value, may generate the new model 140 from the target model 130. For example, the processor may generate the new model 140 by adding a value obtained by combining the first difference value with the change ratio to the target model 130. According to embodiments, the processor may generate the new model 140 based on a value obtained by multiplying the change ratio subtracted from 1 by the first difference value and then adding this result to the third parameter of the target model 130.

According to embodiments, the first difference and the change ratio may be calculated for each corresponding layer of the base model 110, the functional model 120, and the target model 130. The layer may be a structural component of a model, and may execute a series of conversions on input data, gradually extract high-dimensional features, or learn complex expressions. Each layer may perform a specific calculation, and layers may be stacked hierarchically to allow a model to learn and predict. The layers may include an input layer for receiving input data from external sources, an output layer for outputting output data corresponding to the input data, and at least one hidden layer disposed between the input layer and the output layer for receiving data from the input layer, extracting features, and transferring the extracted features to the output layer.

In the description above, the parameter of a model (e.g., the base model 110, the functional model 120 or the target model 130) may be numerical values indicating the structure and trained knowledge of the model, and may include information and rules necessary for the model to process input data and generate appropriate output. The number and value of the parameter may directly affect the performance and complexity of the model and may be indicators for representing the size and capacity of the model. The parameter of the model may include, for example, a weight and/or a bias. The weight may indicate the strength of the connection between nodes of the model, and represent the degree of importance when input data is transmitted to the next layer. Accordingly, a single weight may be allocated to each connection (the connection between nodes). The bias may be a value that indicates the degree to which the model is activated without input data, which allows the model to better represent a specific feature of data. Accordingly, a single bias may be allocated to each node.

FIG. 2 is an outline view illustrating the configuration of an information processing system 230 is connected to a plurality of user terminals 210_1, 210_2 and 210_3 for communication with respect to data processing according to embodiments of the present disclosure. The information processing system 230 may include a system(s) that provides data processing services (e.g., a generation-driven service of a language model). According to embodiments, the information process system 230 may include one or more server devices and/or databases capable of storing, providing, and executing computer-executable programs (e.g., downloadable applications) and data related to data processing services, or one or more distributed computing devices and/or distributed databases based on cloud computing services. For example, the information processing system 230 may include a separate system (e.g., a server) for data processing services.

Data processing services, etc. provided by the information processing system 230 may be provided to users through a data processing application, a web browser application, etc. installed on each of the plurality of user terminals 210_1, 210_2 and 210_3.

The plurality of user terminals 210_1, 210_2 and 210_3 may communicate with the information processing system 230 via a network 220. The network 220 may be configured to enable communication between the plurality of user terminals 210_1, 210_2 and 210_3 and the information processing system 230. Depending on the installation environment, the network 220 may be configured as a wired network such as Ethernet, a wired home network (Power Line Communication), a telephone line communication device, and RS-serial communication, or a wireless network such as a mobile communication network, a Wireless LAN (WLAN), Wi-Fi, Bluetooth, and ZigBee, or a combination thereof. The communication method is not limited, but may include not only a communication method using a communication network (e.g., a mobile communication network, wired Internet, wireless Internet, broadcasting network, satellite network, etc.) that the network 220 may include, but also a near-field wireless communication between the user terminals 210_1, 210_2, and 210_3.

For example, the plurality of user terminals 210_1, 210_2 and 210_3 may transmit commands related to a data processing request, or a user request for data processing to the information processing system 230, and the information processing system 230 may receive the commands.

In FIG. 2, a mobile phone terminal 210_1, a tablet terminal 210_2, and a PC terminal 210_3 are illustrated as examples of user terminals, but the present disclosure is not limited thereto, but the user terminals 210_1, 210_2 and 210_3 may be an arbitrary computing device that allows wired and/or wireless communication and enables installation and execution of data processing applications, etc. For example, the user terminals may include a smartphone, a mobile phone, a navigation device, a computer, a laptop, a digital broadcasting terminal, a Personal Digital Assistant (PDA), a Portable Multimedia Player (PMP), a tablet PC, a game console, a wearable device, an Internet of Things (IoT) device, a Virtual Reality (VR) device, an Augmented Reality (AR) device, etc. In addition, FIG. 2 illustrates that three (3) of the user terminals 210_1, 210_2 and 210_3 communicate with the information processing system 230 via the network 220, but the present disclosure is not limited thereto, and a different number of user terminals may be configured to communicate with the information processing system 230 via the network 220.

FIG. 3 is a block view illustrating internal configurations of the user terminal 210 and the information processing system 230 according to embodiments of the present disclosure. The user terminal 210 may refer to an arbitrary computing device capable of executing a data processing application, etc. and performing wired/wireless communication and include, for example, the mobile phone terminal 210_1, the table terminal 210_2, the PC terminal 210_3, etc. of FIG. 2. As shown in FIG. 3, the user terminal 210 may include a memory 312, a processor 314, a communication module 316, an input and output interface 318. In the similar manner, the information processing system 230 may include a memory 332, a processor 334, a communication module 336, and an input and output interface 338. As shown in FIG. 3, the user terminal 210 and the information processing system 230 may be configured to communicate information and/or data by using each of communication modules 316 and 336 through the network 220. In addition, the input and output device 320 may be configured to input information and/or data into the user terminal 210, and output the information and/or data generated from the user terminal 210 through an input and output interface 318.

The memories 312 and 332 may include any non-transitory computer-readable recording medium. According to embodiments, the memories 312 and 332 may include a permanent mass storage device such as a read-only memory (ROM), a disk drive, a solid state drive (SSD), a flash memory, etc. As another example, the permanent mass storage device such as a ROM, an SSD, a flash memory, a disk drive, etc. may be included in the user terminal 210 or the information processing system 230 as a separate permanent storage device distinct from the memory. In addition, the memories 312 and 332 may store an operating system and at least one program code (e.g., code for an application associated with a data processing service, etc.).

The software components may be loaded from a computer-readable recording medium separately from the memories 312 and 332. The separate computer-readable recording medium may include a recording medium directly connectable to the user terminal 210 and the information processing system 230, for example, a computer-readable recording medium such as a floppy drive, a disk, a tape, a DVD/CD-ROM drive, a memory card, etc. For another example, the software components may be loaded to the memories 312 and 332 through the communication modules 316 and 336 rather than a computer readable recording medium. For example, at least one program may be loaded to the memories 312 and 332 based on computer programs (e.g., an application related to a data processing service, etc.) installed by files provided by developers or a file distribution system that distributes the installment file of an application through the network 220.

The processors 314 and 334 may be configured to process commands of computer programs by performing basic calculations, logic, and input and output calculations. The commands may be provided to the processors 314 and 334 by the memories 312 and 332 or the communication modules 316 and 336. For example, the processors 314 and 334 may be configured to execute commands received according to program codes stored in a recording device such as the memories 312 and 332.

The communication modules 316 and 336 may provide components or functions to allow the user terminal 210 and the information processing system 230 to communicate with each other through the network 220, or components or functions to allow the user terminal 210 and/or the information processing system 230 to communicate with another user terminal or other systems (e.g., a separate cloud system, etc.) For example, the requests or data (e.g., data processing requests or data, etc.) generated by the processor 314 of the user terminal 210 according to the program codes stored in a recording device such as the memory 312, etc. may be transmitted to the information processing system 230 through the network 220 under the control of the communication module 316. Reversely, control signals or commands provided under the control of the processor 334 of the information processing system 230 may be transmitted to the user terminal 210 through the communication module 316 of the user terminal 210 through the communication module 336 and the network 220.

The input and output interface 318 may be a means for interfacing with an input and output device 320. As an example, the input device may include a device such as a camera, a keyboard, a microphone, a mouse, etc., including an audio sensor and/or an image sensor, and the output device may include a device such as a display, a speaker, a haptic feedback device, etc. As another example, the input and output interface 318 may be a means for interfacing with a device that includes integrated configuration or function for performing input and output such as a touch screen. FIG. 3 illustrates that the input and output device 320 is not included in the user terminal 210, but the present disclosure is not limited thereto. The input and output device 320 may be integrated with the user terminal 210 as a single device. In addition, the input and output interface 338 of the information processing system 230 may be connected to the information processing system 230 or may be a means for an interface with a device (not shown) for input or output included in the information processing system 230. FIG. 3 illustrates that input and output interfaces 318 and 338 are components separately formed from the processors 314 and 334, but the present disclosure is not limited thereto, and the input and output interfaces 318 and 338 may be included in the processors 314 and 334.

The user terminal 210 and the information processing system 230 may include further components than those illustrated in FIG. 3. However, it is not necessary to specify the conventional technological components. According to embodiments, the user terminal 210 may be implemented to include at least a part of the input and output device 320 described above. In addition, the user terminal 210 may further include other components such as a transceiver, a Global Positioning System (GPS) module, a camera, various sensors, a database, etc. For example, when the user terminal 210 is a smartphone, the user terminal 210 may generally include components included in a smartphone, and various components such as an acceleration sensor, a gyro sensor, a microphone module, a camera module, various physical buttons, buttons using a touch panel, input and output ports, and a vibrator for vibration may be implemented to be further included in the user terminal 210.

According to embodiments, the processor 314 of the user terminal 210 may be configured to operate a data processing application or a web browser application that provides a data processing service. A program code associated with the application may be loaded into the memory 312 of the user terminal 210. While the application operates, the processor 314 of the user terminal 210 may receive information and/or data provided from the input and output device 320 through the input and output interface 318 or receive information and/or data from the information processing system 230 through the communication module 316, and process the received information and/or data and store the information and/or data in the memory 312. In addition, the information and/or data may be provided to the information processing system 230 through the communication module 316.

While the data processing application operates, the processor 314 may receive voice data, texts, images, videos, etc. input or selected through input devices such as a camera, microphone, etc. including a touch screen, a keyboard, an audio sensor, and/or an image sensor connected to the input and output interface 318, and may store the received voice data, texts, images, and/or videos in the memory 312 or provide the received voice data, texts, images, and/or videos to the information processing system 230 through the communication module 316 and the network 220. According to embodiments, the processor 314 may receive user input input through an input device, and provide data/requests corresponding to the received user input to the information processing system 230 through the network 220 and the communication module 316.

The processor 314 of the user terminal 210 may output information and/or data by transmitting the information and/or data to the input and output device 320 through the input and output interface 318. For example, the processor 314 of the user terminal 210 may output the processed information and/or data through the output device 320 such as a display output capable device (e.g., a touch screen, a display, etc.) or a voice output capable device (e.g., a speaker).

The processor 334 of the information processing system 230 may be configured to manage, process, and/or store information and/or data received from a plurality of user terminals 210 and/or a plurality of external systems. The information and/or data processed by the processor 334 may be provided to the user terminal 210 via the communication module 336 and the network 220.

FIG. 4 is a view illustrated to explain a method for calculating a difference value between respective parameters corresponding to a base model 410 and a functional model 420, FIG. 5 is a view illustrated to explain a method for calculating a change ratio of respective parameters corresponding to the base model 410 and the target model 430 according to embodiments of the present disclosure, FIG. 6 is a view illustrated to explain a method for applying the calculated conversion ratio to the calculated difference value according to embodiments, and FIG. 7 is a view illustrated to explain a method for generating a new model 440 by using a value obtained by applying the calculated conversion ratio to the calculated difference value according to embodiments of the present disclosure. Referring to FIG. 4 to FIG. 7, a process of an electronic device (e.g., the electronic device 100 of FIG. 1) for generating a language model may generate a new model 440 (e.g., the new model 140 of FIG. 1) without learning by using a functional model 420 (e.g., the functional model 120 of FIG. 1) with a specified function added to a base model 410 (e.g., the base model 110 of FIG. 1) and a target model 430 (e.g., the target model 130 of FIG. 1) additionally trained on the base model 410 with learning data of a specified domain. The processor may generate the new model 440 based on a difference value of respective parameters corresponding to the base model 410 and the functional model 420 and a change ratio of respective parameters corresponding to the base model 410 and the target model 430. In the description below, parameters of models (e.g., the base model 410, the functional model 420, the target model 430, or the new model 440) may be expressed in the form of a matrix, elements at the same position in the matrix may represent corresponding parameters of the models, and computational results based on the corresponding parameters may also be expressed in the form of a matrix including elements stored at positions corresponding to the corresponding parameters.

The processor may calculate a difference value 402 (referred to as a first difference value) between parameters 422 and 424 (referred to as a first parameter) of the functional model 420 and parameters (referred to as a second parameter) of the base model 410 corresponding to the first parameters 422 and 424. For example, as illustrated in FIG. 4, when the seventh element, the ninth element 424, the fifteenth element, the nineteenth element, and the twenty-first element 422 of the functional model 420 and other elements than the seventh element, the ninth element, the fifteenth element, the nineteenth element, and the twenty-first element of the base model 410 corresponding thereto are identical to each other, the first difference value 402 expressed as a matrix may also have other elements than the seventh element, the ninth element, the fifteenth element, the nineteenth element, and the twenty-first element as 0 (zero). The first difference value 402 may be calculated using the following equation 1.

$${τ}_{i} = {θ}_{inf , i} - {θ}_{base , i} \qquad [ Equation 1 ]$$

Where i is a natural number, τᵢ denotes the ith element of the first difference value 402, θ_{inf,i} denotes the ith element (or the ith parameter) of the functional model 420, and θ_{base,i} denotes the ith element (or the ith parameter) of the base model 410.

The processor may calculate a change ratio 404 of parameters 432 and 434 (referred to as a third parameter) of the target model 430 corresponding to a second parameter of the base model 410. According to embodiments, the processor may calculate a difference value (referred to as a second difference value) between the third parameters 432 and 434 of the target model 430 and the second parameter of the base model 410, and input the second difference value into an activation function 510 to obtain the change ratio 404. The activation function 510 may include at least one of a sigmoid function or a ReLU function. According to embodiments, the processor may obtain the absolute value of the second difference value and then normalize the absolute value before inputting the second difference value to the activation function 510. For example, the processor may adjust the input value of the activation function 510 to be a real number greater than or equal to 0 (zero) and less than or equal to 1 (one). For example, as illustrated in FIG. 5, when the sixth element, the ninth element 434, the fourteenth element, the seventeenth element, the twenty-first element 432, and the twenty-fifth element of the target model 430 and the sixth element, the ninth element, the fourteenth element, the seventeenth element, the twenty-first element, and the twenty-fifth element of the base model 410 corresponding thereto are identical to each other, the second difference value expressed as a matrix may also have other elements than the sixth element, the ninth element, the fourteenth element, the seventeenth element, the twenty-first element, and the twenty-fifth element as 0 (zero). In addition, when the absolute value of the second difference value is input to the activation function 510 after the normalization process, depending on the characteristics of the activation function 510, in the case of an element (e.g., the seventeenth element) of which difference value is not large, the corresponding element (e.g., the seventeenth element) of the output change ratio 404 may also have 0 (zero). In the case of an element (e.g., the sixth element, the ninth element, the fourteenth element, the twenty first element, and the twenty fifth element) of which difference value is greater than a specific threshold value, the corresponding element (e.g., the sixth element, the ninth element 524, the fourteenth element, the twenty first element 522, and the twenty fifth element) of the output change ratio 404 may have a non-zero value. The change ratio 404 may be calculated through the following equation 2.

$${λ}_{i} = f ( {θ}_{target , i -} {θ}_{b ase , i} ) \qquad [ Equation 2 ]$$

Where i is a natural number, λᵢ denotes the ith element of the change ratio 404, function f denotes an activation function 510, θ_{target,i} denotes the ith element (or the ith parameter) of the target model 430, and θ_{base,i} denotes the ith element (or the ith parameter) of the base model 410.

In addition, in the process of normalizing the absolute value of the second difference value before inputting the second difference value into the activation function 510, when the activation function 510 is a sigmoid function, the following equations 3 and 4 may be used.

$$θ = abs ( {θ}_{target , i} - {θ}_{b ase , i} ) \qquad [ Equation 3 ]$$

$$f ( θ ) = σ ( a * ( {θ}_{j} - {θ}_{min} ) / ( {θ}_{max} - {θ}_{min} ) - b ) \qquad [ Equation 4 ]$$

Where i is a natural number, function f denotes the activation function 510, function σ denotes a sigmoid function, θ_{target,i} denotes the ith element (or the ith parameter) of the target model 430, θ_{base,i} denotes the ith element (or the ith parameter) of the base model 410, and a and b denote parameters for adjusting the input value of the sigmoid function to be a real number greater than or equal to 0 (zero) and less than or equal to 1 (one). In addition, abs function denotes an absolute value function for each element of the input matrix, θₘᵢₙ denotes the minimum value among the elements of input θ, and θₘₐₓ denotes the maximum value among the elements of input θ. According to embodiments, a may be 12, and b may be 6.

Equations 3 and 4 may be for calculating the change ratio based on the difference between the target model 430 and the base model 410. To adjust the calculated change ratio to be a real number value greater than or equal to 0 and less than or equal to 1, the processor may also convert the value input to the activation function 510 to be a value greater than or equal to 0 and less than or equal to 1. The processor may obtain the absolute value of each element of the parameter difference matrix between the target model 430 and the base model 410, as in equation 3, and may apply the absolute value to the min-max normalization algorithm as in equation 4.

The processor may generate a new model 440 from the target model 430 based on the first difference value 402 and the change ratio 404. For example, the processor may generate the new model 440 by adding a value obtained by combining the first difference value 402 with the change ratio 404 to the target model 430. According to embodiments, the processor may generate the new model 440 by adding a value 408 obtained by multiplying a value 406 obtained by subtracting the change ratio 404 from 1 (one) by the first difference value 420 to the third parameters 432 and 434 of the target model 430. For example, as illustrated in FIG. 6, among the elements of the change ratio 404 expressed as a matrix that may not be 0 (zero) (e.g., the sixth element, the ninth element 524, the fourteenth element, the twenty-first element 522, and the twenty-fifth element), the matrix elements of the value 406 subtracted from 1 (e.g., the sixth element, the ninth element 624, the fourteenth element, the twenty first element 622, and the twenty fifth element) may have the value other than 1. Accordingly, when the matrix elements (e.g., the sixth element, the ninth element 624, the fourteenth element, the twenty-first element 622, and the twenty-fifth element) of the value 406 obtained by subtracting the change ratio 404 from 1 (one) have the value other than 1 (one), the value 408 obtained by multiplying the value 406 obtained by subtracting the change ratio 404 from 1 (one) by the first difference value 402 may be affected. For example, as illustrated in FIG. 6, when the seventh, ninth, fifteenth, nineteenth, and twenty-first elements among the matrix elements of the first difference value 402 have a non-zero value, the seventh, fifteenth, and nineteenth elements among the matrix elements of the value 406 obtained by subtracting the change ratio 404 from 1 (one) may have 1 (one), so the first difference value 402 may be applied as it is, but the ninth element 624 may have 0 (zero), so that the first difference value 402 may not be applied, and the twenty-first element 622 may have a value between 0 and 1, so the first difference value 402 may be applied in a limited manner. When the new model 440 is generated by adding the value 408 obtained by multiplying the value 406 obtained by subtracting the change ratio 404 from 1 (one) by the first difference value 402, to the third parameters 432 and 434 of the target model 430, the parameters 442 and 444 of the new model 440 may differ from those of the target model 430 in that the value 408 obtained by multiplying the value 406 obtained by subtracting the change ratio 404 from 1 (one) by the first difference value 402 is not 0 (zero). For example, as illustrated in FIG. 7, when the seventh, the fifteenth, the nineteenth, and the twenty-first elements among the matrix elements of the value 408 obtained by multiplying the value 406 obtained by subtracting the change ratio 404 from 1 (one) by the first difference value 402 have a non-zero value, the seventh, the fifteenth, the nineteenth, and the twenty-first elements 442 among the parameters 442 and 444 of the new model 440 may have differences from the target model 430. This may mean that at least some of the corresponding parameter of the functional model 420 may be applied to the target model 430. The new model 440 may be calculated through equation 5 below.

$${θ}_{new , i} = {θ}_{target , i} + ( 1 - {λ}_{i} ) * {τ}_{i} \qquad [ Equation 5 ]$$

Where, i is a natural number, θ_{new,i} denotes the ith element (or the ith parameter) of the new model 440, θ_{target,i} denotes the ith element (or the ith parameter) of the target model 430, λᵢ denotes the ith element of the change ratio 404, and τᵢ denotes the ith element of the first difference value 402.

FIG. 8 is a view illustrated to explain an activation function used in calculating a change ratio according to embodiments of the present disclosure. Referring to FIG. 8, a processor of an electronic device (e.g., the electronic device 100 of FIG. 1) for generating a language model may generate a new model (e.g., the new model 140 of FIG. 1) without a learning process by using a functional model (e.g., the functional model 120 of FIG. 1) with a specified function added to a base model (e.g., the base model 110 of FIG. 1) and a target model (e.g., the target model 130 of FIG. 1) additionally trained on the base model with learning data of a specified domain. The processor may generate the new model based on a difference value between corresponding parameters of the base model and the functional model and a change ratio of corresponding parameters of the base model and the target model.

According to embodiments, the processor may calculate a difference value between the parameter of a target model and the parameter of a base model corresponding thereto, and input the calculated difference value into an activation function 810 to obtain a change ratio. During the process, the processor may obtain an absolute value of the calculated difference value and then normalize the absolute value before inputting the calculated difference value into the activation function 810. For example, the processor may adjust an input value (x) of the activation function 810 to be a real value greater than or equal to 0 (zero) and smaller than or equal to 1 (one). According to embodiments, the processor may use an activation function 820 that changes the parameter of the activation function 810. For example, when the activation function 810 is a sigmoid function, the processor may use the activation function 820 in which the input value x is replaced with (12x-6). The input value x may be a real value greater than or equal to 0 (zero) and smaller than or equal to 1 due to parameters 12 and 6.

FIG. 9 is a view illustrating pseudo code used to generate a language model according to embodiments of the present disclosure. The pseudo codes illustrated in FIG. 9 may represent pseudo codes corresponding to equations 1, 2 (and equations 3 and 4), and 5 described above. For example, a first pseudo code 910 may correspond to equation 1 and may include a code for calculating a difference value between a parameter of a functional model (e.g., the functional model 120 of FIG. 1) and a parameter of a base model (e.g., the base model 110 of FIG. 1) corresponding thereto. In addition, a second pseudo-code 920 may include a code for calculating a change ratio of the parameter of a target model (e.g., the target model 130 of FIG. 1) corresponding to the parameters of the base model, corresponding to equations 2, 3, and 4. In addition, a third pseudo-code 930 may include code for calculating a change ratio of the parameter of a target model (e.g., the target model 130 of FIG. 1) corresponding to equation 5, based on a difference value calculated through equation 1 and a change ratio calculated through equations 2, 3, and 4, from the target model.

FIG. 10 is a view illustrated to explain a method for generating a language model according to embodiments of the present disclosure. Referring to FIG. 10, a processor of an electronic device (e.g., the electronic device 100 of FIG. 1) for generating a language model may obtain, in step S1010, a base model (e.g., the base model 110 of FIG. 10), a functional model (e.g., the functional model 120 of FIG. 1), and a target model (e.g., the target model 130 of FIG. 1). For example, the processor may obtain a base model pre-trained with a large-scale corpus, a functional model with a specified function added to the base model, and a target model additionally trained on the base model with learning data of a specified domain. According to embodiments, the specified function may include at least one of a response generation function for commands, a chat function, a retrieval-augmented generation function, a context expansion function, or a coding function. According to embodiments, the specified domain may include at least one of a language domain from at least one other country, an expert knowledge domain, or a corporate domain.

In step S1020, the processor may calculate a difference value between a first parameter of the functional model and a second parameter of the base model. For example, the progressor may calculate a difference value between the respective parameters of the base model and the functional model.

In step S1030, the processor may calculate a change ratio of the third parameter of the target model with respect to the second parameter. For example, the processor may calculate a change ratio of respective corresponding parameters of the base model and the target model. According to embodiments, the processor may calculate a difference value between the third parameter of the target model and the second parameter of the base model, and input the calculated difference value into an activation function to obtain the change ratio. The activation function may include at least one of a sigmoid function or a ReLU function. According to embodiments, before inputting the calculated difference value into the activation function, the processor may obtain an absolute value of the calculated difference value and then normalize the absolute value. For example, the processor may adjust the input value of the activation function to be a real number value greater than or equal to 0 and less than or equal to 1.

In step S1040, based on the difference value and the change ratio, the processor may generate a new model (e.g., the new model 140 of FIG. 1) from the target model. For example, the processor may generate a new model by adding a value obtained by combining a difference value between the first parameter of the functional model and the second parameter of the based model with a change ratio between the third parameter of the target model for the second parameter of the base model to a target model. According to embodiments, the processor may generate a new model based on the value obtained by multiplying the value obtained by subtracting the change ratio of the third parameter of the target model with respect to the second parameter of the base model from 1 (one) by the difference value between the first parameter of the functional model and the second parameter of the base model and then adding the value to the third parameter of the target model.

According to embodiments, the difference value between the first parameter of the functional model and the second parameter of the base model and the change ratio of the third parameter of the target model with respect to the second parameter of the based model may be calculated for each corresponding layer of the based model, the functional model, and the target model. The layer may include an input layer for receiving input data from outside, an output layer for outputting output data corresponding to the input data, and at least one hidden layer disposed between the input layer and the output layer, configured to receive data from the input layer and extract features of the data, and transmit the features to the output layer. In addition, the parameter of a model (e.g., the base model, the functional model or the target model) may include at least one of a weight or a bias.

The flowchart and description above are merely examples and may be implemented differently in some examples. For example, in some examples, the order of respective steps may be changed, some steps may be repeatedly performed, some steps may be omitted, or some steps may be added.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, etc. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, etc. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transmission of a computer program from one place to another. The storage media may also be any available media that may be accessible to a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessible to a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or apparatus, and storage may be similarly influenced across a plurality of apparatus. Such apparatus may include PCs, network servers, and portable apparatus.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

What is claimed is:

1. A method performed by an apparatus, the method comprising:
obtaining a base model pre-trained with a large-scale corpus, a functional model comprising a specified function added to the base model, and a target model additionally trained on the base model with learning data of a specified domain;
determining a first difference value between a first parameter of the functional model and a second parameter of the base model corresponding to the first parameter;
determining a change ratio of a third parameter of the target model corresponding to the second parameter with respect to the second parameter; and
generating, based on the first difference value and the change ratio, a new language model from the target model.

2. The method as claimed in claim 1, wherein the determining of the change ratio comprises:
determining a second difference value between the third parameter and the second parameter; and
obtaining the change ratio by inputting the second difference value to an activation function of an artificial intelligence neural network.

3. The method as claimed in claim 2, wherein the activation function comprises at least one of a sigmoid function or a ReLU (Rectified Linear Unit) function.

4. The method as claimed in claim 2, further comprising:
before inputting the second difference value to the activation function, obtaining an absolute value of the second difference value and normalizing the absolute value, wherein the inputting the second difference value to the activation function comprises inputting the normalized absolute value to the activation function.

5. The method as claimed in claim 4, wherein the generating of the new language model comprises:
generating the new language model based on a value obtained by:
multiplying the change ratio subtracted from one by the first difference value; and
adding a result of the multiplication to the third parameter.

6. The method as claimed in claim 1, wherein the first difference value and the change ratio are determined for each corresponding layer of the base model, the functional model, and the target model.

7. The method as claimed in claim 1, wherein the specified function comprises at least one of a response generation function for commands, a chat function, a retrieval-augmented generation function, a context expansion function, or a coding function.

8. The method as claimed in claim 1, wherein the specified domain comprises at least one of a language domain from at least one other country, an expert knowledge domain, or a corporate domain.

9. A non-transitory computer-readable recording medium storing computer-readable commands that, based on the computer-readable commands being executed by at least one processor, is configured to cause an apparatus to:
obtain a base model pre-trained with a large-scale corpus, a functional model comprising a specified function added to the base model, and a target model additionally trained on the base model with learning data of a specified domain,
determine a first difference value between a first parameter of the functional model and a second parameter of the base model corresponding to the first parameter,
determine a change ratio of a third parameter of the target model corresponding to the second parameter with respect to the second parameter, and
generate, based on the first difference value and the change ratio, a new language model from the target model.

10. An electronic device, comprising:
a memory; and
at least one processor connected to the memory and configured to execute computer-readable commands stored in the memory,
wherein the computer-readable commands, based on the computer-readable commands being executed by the at least one processor, are configured to cause the electronic device to:
obtain a base model pre-trained with a large-scale corpus, a functional model comprising a specified function added to the base model, and a target model additionally trained on the base model with learning data of a specified domain,
determine a first difference value between a first parameter of the functional model and a second parameter of the base model corresponding to the first parameter,
determine a change ratio of a third parameter of the target model corresponding to the second parameter with respect to the second parameter, and
generate, based on the first difference value and the change ratio, a new language model from the target model.

11. The electronic device as claimed in claim 10, wherein the computer-readable commands, based on the computer-readable commands being executed by the at least one processor, are configured to cause the electronic device to:
determine a second difference value between the third parameter and the second parameter, and
obtain the change ratio by inputting the second difference value to an activation function of an artificial intelligence neural network.

12. The electronic device as claimed in claim 11, wherein the activation function comprises at least one of a sigmoid function or a ReLU function.

13. The electronic device as claimed in claim 11, wherein the computer-readable commands, based on the computer-readable commands being executed by the at least one processor, are configured to cause the electronic device to:
before inputting the second difference value into the activation function, obtain an absolute value of the second difference value and normalize the absolute value; and
input the second difference value to the activation function by inputting the normalized absolute value to the activation function.

14. The electronic device as claimed in claim 13, wherein the computer-readable commands, based on the computer-readable commands being executed by the at least one processor, are configured to cause the electronic device to:
generate the new language model based on a value obtained by:
multiplying the change ratio subtracted from 1 by the first difference value; and
adding a result of the multiplication to the third parameter.

15. The electronic device as claimed in claim 10, wherein the first difference value and the change ratio are determined for each corresponding layer of the base model, the functional model, and the target model.
